(19) United States
(12) Patent Application Publication
(10) Pub. No.: US 2017/0262828 A1
(43) Pub. Date: Sep. 14, 2017

(54) UNIVERSAL CHECK-OUT SYSTEM FOR MOBILE PAYMENT APPLICATIONS/PLATFORMS

(71) Applicant: Mobile Payments Interchange, LLC, Daytona Beach, FL (US)

(72) Inventor: Sergio Luciani, Sarasota, FL (US)

(73) Assignee: Mobile Payments Interchange, LLC, Daytona Beach, FL (US)

(21) Appl. No.: 15/609,110

(22) Filed: May 31, 2017

Related U.S. Application Data
(63) Continuation of application No. 14/292,543, filed on May 30, 2014.
(60) Provisional application No. 61/964,518, filed on Jan. 7, 2014.
(60) Provisional application No. 61/855,209, filed on May 10, 2013.

(51) Int. Cl. G06Q 20/20; G06Q 20/32

(52) U.S. Cl. CPC G06Q 20/204; G06Q 20/3274

(57) ABSTRACT

A payment processing method comprising receiving, through a payment application running on a mobile device of a customer, QR code data from an optical scanning device of the mobile device, receiving a client transaction settlement request comprising the QR code data and a customer ID, and receiving a processor transaction settlement request comprising the Merchant ID, the POS Terminal ID, and a transaction amount. The method further comprises verifying the Merchant ID and POS Terminal ID are identical between the client transaction settlement request and processor transaction settlement request, combining the client transaction settlement request and processor transaction settlement request into a combined transaction settlement request comprising the Merchant ID, the transaction amount, and customer financial instrument information, and transmitting the combined transaction settlement request to a processor payment gateway, receiving a transaction result, and transmitting the transaction result.

### RELATED APPLICATIONS

This application is a continuation application and claims the benefit under 35 U.S.C. §120 of U.S. patent application Ser. No. 14/292,543 filed on May 30, 2014 titled Universal Check-Out System for Mobile Payment Applications/Platforms, which in turn claims priority U.S. Provisional Patent Application Serial Nos. 61/855,209 filed on May 10, 2013 and titled Universal check-out system for mobile payment applications/platforms and 61/964,518 filed on Jan. 7, 2014 and titled Universal acceptance system for mobile payment applications/platforms using processor closed loop system or interchange, the entire contents of which are incorporated herein by reference.

### FIELD OF THE INVENTION

The present invention relates to systems and methods for processing payments.

### BACKGROUND

Today, almost all merchants, whether brick and mortar or e-commerce (online-based) businesses, accept electronic payments (e.g., credit cards, debit cards, gift cards, in addition to private payment solutions such as PayPal® and Google Wallet®) as tender for transactions. The emergence of smart phones contributed to the development of mobile payment solutions which now account for a significant portion of e-commerce, and are poised to become a large if not preponderant portion of the electronic payments ecosystem. Electronic payments are also accepted by increasing numbers of vending machines, kiosks, automated tellers and other systems without a human merchant needed to conduct the transaction or to process payment as tender for the transaction. The underlying system that allows merchants to accept payment for, clear these transactions and receive the appropriate credit and acknowledgment, while providing the customer with the necessary link to their credit/debit solutions, consists of an architecture involving at least some of the following parties and components, defined as follows:
Acquiring Bank: The Acquiring Bank holds the contract for providing payment processing services to the merchant. The merchant account is a contract under which the Acquiring Bank extends a line of credit to a merchant who wishes to accept credit card transactions. The Acquiring Bank holds all the risk on every transaction as well as the operation of every registered acquiring ISO/MSP and their sub-agents and are responsible for all Association fines.
Association: The consumer payment system whose members are the financial institutions that issue payment cards and/or sign merchant to accept payment cards.
Back-End Network: The platform that takes captured transactions from the Front-End Network and settles them through the Interchange system. The back-end generates daily ACH files for merchant settlement. Other functions typically handed on the back-end include chargeback handling, retrieval request and monthly statements. Usually provided by the Processor or Acquiring/Issuing Bank and/or their third party agents.
BIN-IIN: A number used to identify the issuer. Part of a payment card number, typically the first six digits of a payment card number assigned to a bank that issues payment cards (e.g. credit cards). BIN-IIN services allow an issuing bank to receive requests for settlement of transaction involving the “issued card” via the Interchange back to the merchant.
Cardholder: Authorized user of a payment card (e.g. credit, debit, or gift card). See also, Customer.
Closed-loop card solution: A card recognized by the front end gateway of a processor as a financial instrument whose clearance process should be routed outside of the Interchange system.
Customer: Individual having a mobile payment application downloaded on his/her mobile device (which typically is a mobile phone, smart phone, or tablet computer). Also called Mobile Application User.
Front-end Network: The platform that the credit card terminal/gateway communicates with when approving a transaction. The front-end is responsible for the authorization and capture portion of a credit card transaction. Additional front-end platform interconnections may be required to support ACH and debit transaction. Usually provided by the acquiring bank, processor, or processor's approved/certified third party.
Independent Sales Organization (ISO)/Member Services Provider (MSP) (“Processor”): Entity that solicits merchants on behalf of an Acquiring Bank for payment card acceptance and enables card payments from customers. Acquirer's generally hold responsibility for providing customer service, merchant-level support, merchant-level compliance with Association rules and underwriting of merchant accounts. Sometimes called Processor.
Interchange: The process and communication network, by which all parties involved in a credit card transaction (i.e., processors, acquirer, issuers, etc.) manage the processing, clearing and settlement of credit card transactions, including the assessment and collection and/or distribution of fees between all parties.
Issuing Bank: A financial institution that issues payment cards and maintains a contract with cardholders for repayment.
Merchant: Authorized acceptor of payment cards for the payment of goods and services provided to customer.
Mobile Payment Platforms/Solutions (“MPS”): A software/hardware based system that enables mobile devices such as telephones to communicate with parties involved in a credit or debit transaction and providing the means by which credit data pertinent to the owner of the device is transmitted to some of the parties involved to settle a transaction. The Platform can perform processing functions directly to an acquiring bank or can be integrated with one or more processor to perform clearing functions.
Payment Gate way: The virtual device (software) used by the merchant to communicate information to the Acquirer's Front-End Network. The Gateway is certified as PCI compliant and can collect or retrieve credit data information from a “Vault” to be forwarded along with the total amount due to the issuing bank of the credit instrument for approval of the transaction. It is the means by which a physical point of sale terminal, located at a merchant's retail outlet, communicates and settles credit/debit transactions. Payment gateways interface with a merchant's POS system and pass that data to a Front-End Authorization Network. Usually provided by Acquiring Bank, Processor or processor's agent (ISO) or third party integrated with processor/Acquiring Bank.
POS/Terminal: The physical or virtual device used by the merchant to communicate information to the Acquirer's Front-End Network. Usually provided by acquiring bank, processor, or processor's agent (ISO) or third party integrated with processor/Acquiring Bank.
Financial Instrument/Card: A traditional magnetic stripe card recognizable by the BIN-IIN management system or by the issuing bank as a special card whose requests will be redirected to the “Server.” The card contains information relative to the merchant and the Terminal ID Vault System: software environment where processors store sensitive data such as credit and personal data to be used for many purposes including applications by a third party which can use such data as related to their application without need to actually have direct access.
The Server: A computing device receiving and sending information from the BIN-IIN management system. A closed-loop card solution or the issuing bank regarding activing (swipes) relative to the financial instrument/card. The information includes transaction amount and merchant and terminal data. The server receives and sends information from all Mobile Payment Platforms attempting to clear a transaction from a merchant's POS and communicates back to the MPS.
Virtual Terminal: Processor's administrative system which gives access to merchant of all activity occurring in merchant settlement of credit-debit transactions.

Currently when a merchant and a processor execute an agreement so that the processor will handle the merchant's electronic payment transactions, the processor creates a merchant account for the merchant that identifies the merchant and defines the parameters related to that agreement. Such agreement defines the types of transactions that the merchant is authorized to undertake and includes merchant ID, processor ID and a merchant account ID. This data is stored in a secure environment usually identified as Payment Card Industry (“PCI”) compliant. Once the payment interface unit is configured so that communication with the processor occurs within the required parameters, including a merchant profile and identification of the specific point of sale (“POS” or “Terminal”) unit, this allows for identification of the parameters related to the merchant agreement with the processor and of the specific POS terminal unit involved in the transaction. The payment interface unit will create a transaction request based on the customer profile (or “customer ID”), the processor application, the merchant profile (or “merchant ID”), the specific POS Terminal ID, and the total payment amount due. Accordingly, third party vendors are utilized to install and configure the payment interface units at the merchant POS Terminal sites, so that they address the processor's application requirements and enabling communications channels between the specific merchant and specific processor. Within this framework, credit-debit processing of transactions between consumer and merchant (C to B) or between merchants (B to B) are undertaken with either (a) card-present status (where the actual card having a magnetic stripe is swiped on a magnetic card reader, said magnetic stripe containing two encoded tracks of information about the card, the cardholder and the issuing financial institution), or (b) card-not-present status (where card information is conveyed orally/manually via a telephone a fax or other media input). E-commerce transactions in general qualify as card not present status as the data is manually entered into the merchant system remotely, with various systems integrated to address and minimize the likelihood of fraud.

The emergence of mobile e-commerce and the prevalent use of mobile devices (such as smart phones and tablets) by the general public has brought a new dimension to credit card transactions with the adoption of mobile payment platforms, where consumers make use of their mobile devices and enabled wireless internet connections to a payment clearing environment (Mobile Payment Platform/System (“MPS”)) to pay for goods or services using their mobile device. The transaction is initiated by the consumer via a mobile payment application resident on the consumer/customer's mobile device which communicates to the MPS, which in turn transmits to the processor the relevant total due for the transaction, the merchant ID, and consumer's credit card information stored on the mobile device.

While this new functionality is expected to eventually take a large if not dominant share of the credit/debit transaction ecosystem, it is still limited by the fact that each mobile application residing on a mobile device, and it's corresponding MPS, in order to communicate the information necessary to clear a credit/debit transaction, needs to be integrated with the specific processor company used by the merchant and in addition with the merchant's POS system. While there is a limited amount of processors, the number of software POS systems and hardware providers is so large and diverse that ensuring functionality under all these platforms by a MPS and its Mobile Payment Application is a near impossibility due to the expense involved in ensuring compatibility. This process is being addressed in a number of different ways aimed at minimizing the need for integration at the merchant level, but still relies on the necessity for each merchant to integrate in some form with these existing solutions, such as by adding additional integrating hardware to the merchant's existing POS hardware. This integration obstacle is the major problem with the present state of the art in mobile payment systems for which the present invention presents a solution.

### SUMMARY OF THE INVENTION

The present invention generally relates to the field of e-commerce and mobile payments for consumer transactions at the point of sale. Mobile payments are by definition the process by which payment for a service is undertaken by a customer via a telephone (hence the mobility definition). Ordinarily enabling such payment solution requires that the POS terminal system be modified to accommodate and integrate the mobile payment platform with the merchant's existing POS system (comprised of one or more POS terminals i.e. cash registers). Given the diverse and non-homogeneous nature of these systems (that range from complex server or PC-based solutions to basic magnetic card reader units) and the different architectures involving POS software and actual cash registers, it is currently impossible to implement mobile payment solutions over a large number of merchants without individual set up and integration. This process precludes mobile solutions from enabling a large number of merchants economically and in a short period of time.

The present invention proposes to introduce novel and unique architecture and process methodology, making use of existing industry components, whereby a mechanism is implemented, by which single or multiple mobile payment platforms can be enabled in an existing processor's merchant base and each merchant's POS terminal or via a magnetic card reader connected to the POS Terminal, without the necessity of implementing expensive integration solutions at the merchant level. By the use of this novel process and architecture, payment of a total due at checkout at a merchant is made possible via the customer's use of a mobile payment application residing in that customer's mobile device (smart phone, tablet, etc.) communicating to a MPS that communicates with the merchant's payment processor. Transaction results (e.g. payment confirmation or denial) are received and acknowledged by the POS Terminal system and by the customer's Mobile Payment Application.

### BRIEF DESCRIPTION OF THE DRAWINGS

FIG. 1. shows a schematic view of a fully integrated mobile payment system consistent with a first and second preferred embodiments of the invention, without any additional hardware integration, herein disclosed by the present invention.

FIG. 2. shows a schematic view of a fully integrated mobile payment system consistent with a third and fourth preferred embodiments of the invention, said mobile payment system having an additional device connected to the merchant's POS system, herein disclosed by the present invention.

FIG. 3. shows a schematic view of a general flow of data during a mobile payment transaction.

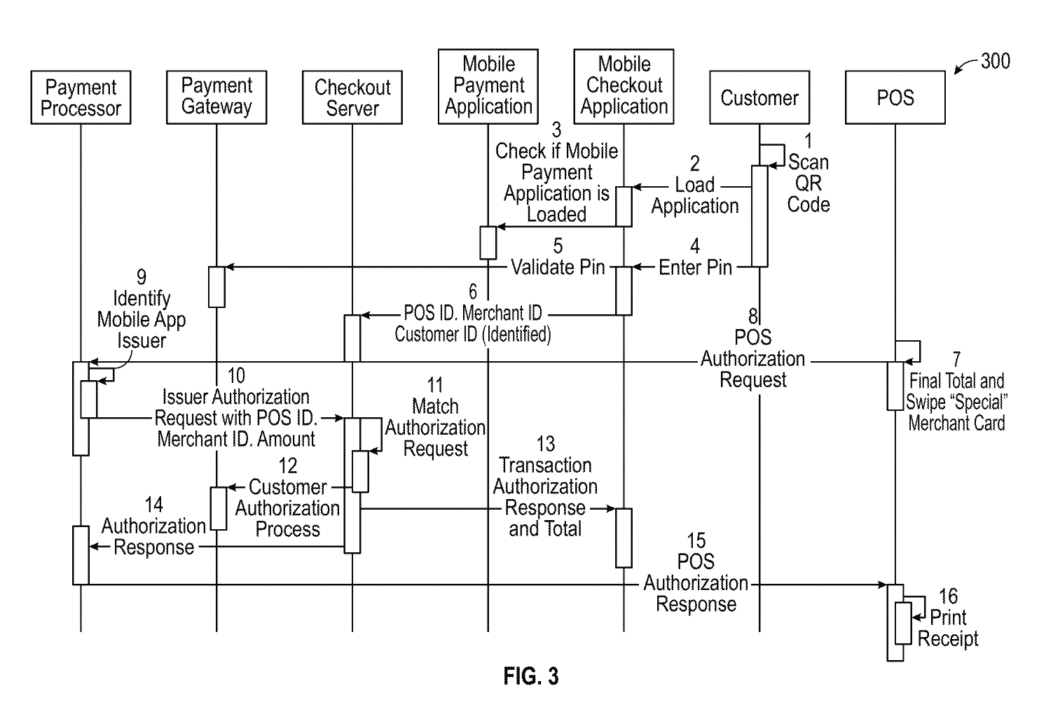

FIG. 4. shows a schematic view of a general closed-loop solution herein described.

FIG. 5. shows a schematic view of a general open-loop solution herein described.

### DETAILED DESCRIPTION OF THE INVENTION

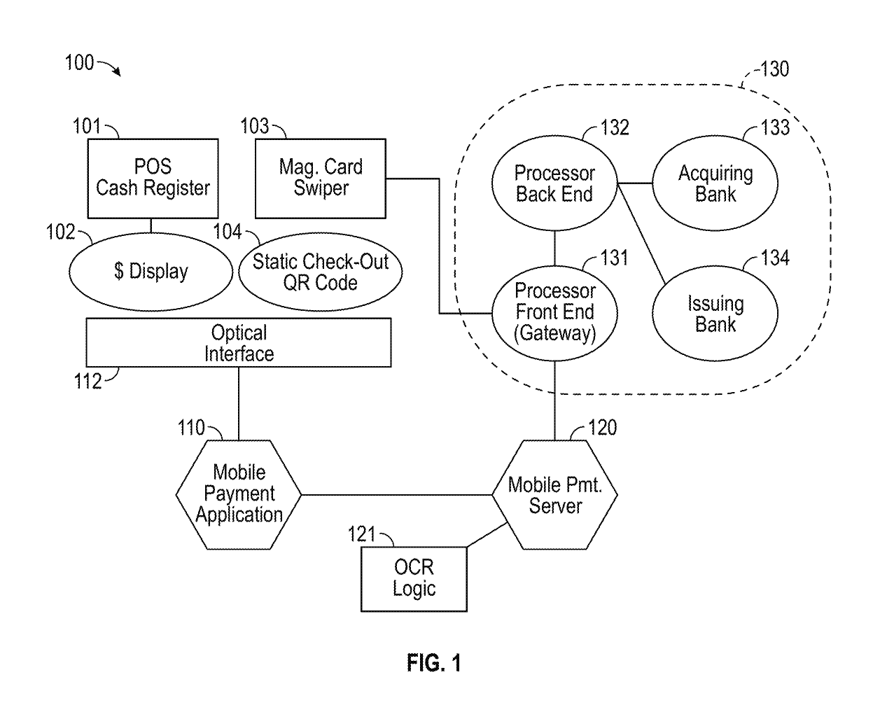

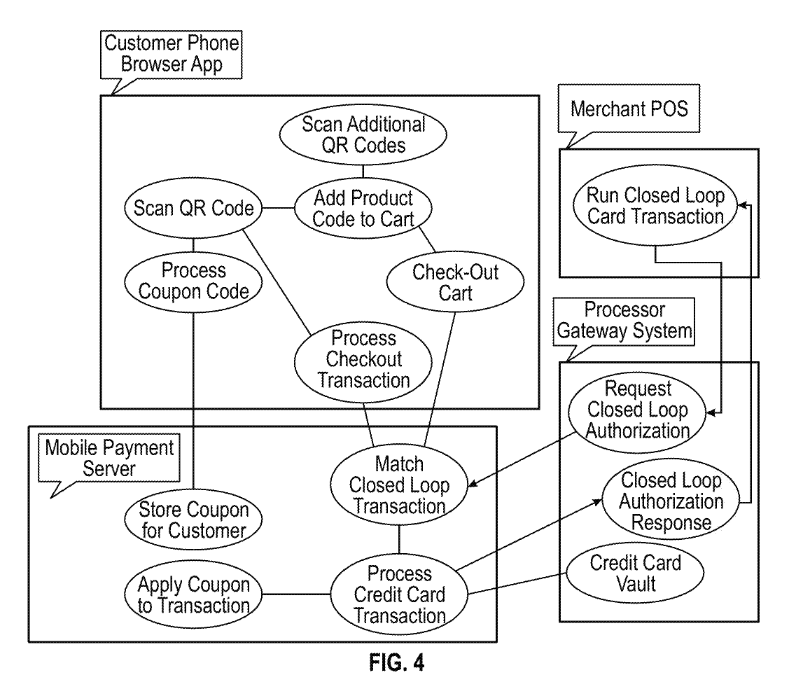

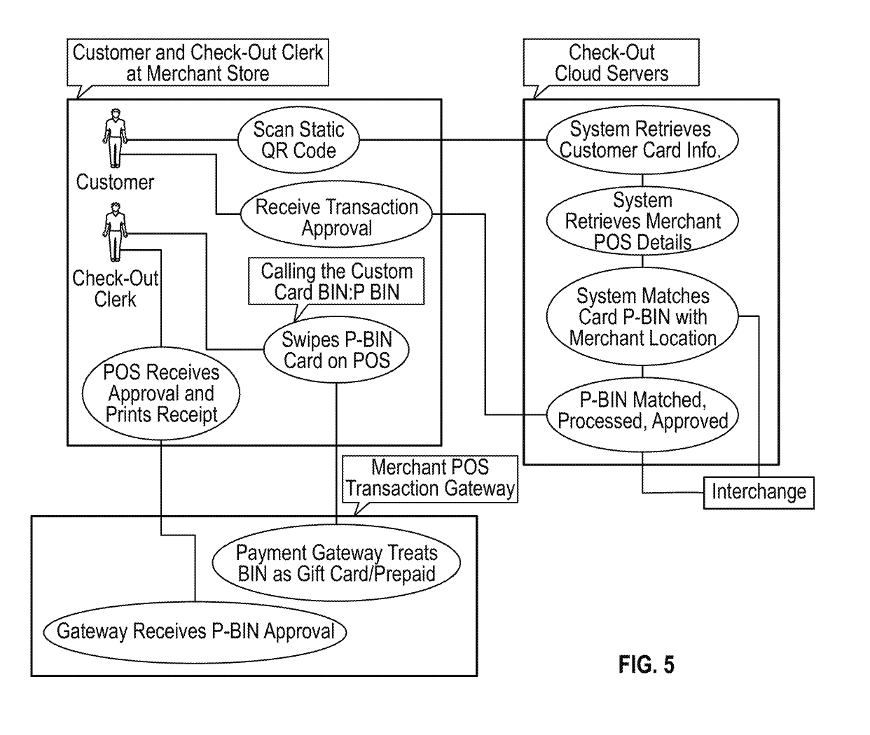

To achieve the foregoing utility in accordance with the purpose of the invention, a preferred embodiment of a process and architecture are described. FIG. 1. shows a process 100 and architecture for mobile payments between a customer and a merchant without the need to integrate additional hardware with the merchant's POS terminal system. In this embodiment of the invention, a merchant having a POS Terminal system 101 (e.g. cash register), either having a built-in magnetic card reader (“card swiper”) or being connected to a magnetic card swiper 103 such as Veriphone® model VX510 or Ingenico® model ICT-220 via RS232 or similar connection means known in the art, displays a total amount due received from the terminal. The card swiper 203 is connected to the internet and has basic browser and communication functions with the merchant's payment processor via that processor's payment gateway. Once the total due is received from the POS 101, the card swiper 103 is ready to receive data from its magnetic scanner. The customer, possessing a mobile device with capabilities of GPS location identification, radio and near-frequency communication capabilities, mobile data/internet functionality, and optical scanning capabilities, such as an optical scanning device 111, and having a mobile payment application 110 designed to utilize one or more of these functions, scans a static matrix/QR code 104 (“OR code”) displayed near the POS 101 via the mobile device's payment application 110 and is taken to a mobile payment server (MPS) 120. This QR code 104 can be printed on any suitable media (e.g. paper, transparency, laminate, sticker) and placed where visible to the customer using the Mobile Payment Application 110. Multiple QR codes 104 may be displayed at once, each addressing a different payment platform depending on the customer's preference provided that each individual payment platform could communicate with the device either directly or via a unique MPS integration. Each QR code 104 contains data identifying the merchant ID, POS Terminal ID, and merchant processor information. The mobile payment application 110 transmits these three pieces of data, along with the customer's information and customer's financial instrument information, which are stored or entered on the mobile device, to the MPS 120. The MPS 120 receives this information, and retrieves customer ID and customer's financial instrument (e.g. credit card information from a PCI-compliant environment and sends a request to the processor 130 that includes customer's credit card information, customer ID, merchant ID, and POS ID. The merchant's card swiper 103, being set to wait for input by the POS Terminal 101, receives data by the merchant then swiping a merchant magnetic card (“Merchant Card”) containing data that enables the card swiper 103 to transmit to processor 130 as if receiving the customer's card. The Merchant Card contains a set of data that can be either (A) a closed-loop solution, acting as a flag to the processor 130 and instructing the processor's payment gateway 131 to route the request to settle the transaction to the MPS 120 server in a similar manner to a gift card solution or other closed-loop solution implemented by the processor's payment gateway 131, whereby the processor's payment gateway 131 software has been modified to recognize a specific data range to acts as a redirect of the settlement process internally, as shown in FIG. 4; or (B) as an open-loop solution, acting as a normal credit card transaction, whereby the MPS 120 has been previously assigned a BIN number or data range recognized by the Interchange and acts effectively as an Issuing Bank, as shown in FIG. 5. The MPS 120 receives the Merchant ID, POS Terminal ID, customer ID and customer's financial instrument information from the mobile payment application 110 when the customer optically scans the merchant's matrix/QR code 104, and also receives the Merchant ID, POS Terminal ID, and the total amount due from the processor's payment gateway 131 as a request for settlement of the transaction. The MPS 120 compares these two flows of data, verifies the information is the same, and forwards this data to the processor 130 to settle the transaction. The processor 130 completes the transaction, and sends notification of transaction results to the POS Terminal 101. The POS 101 and/or card swiper 103 may print a receipt and acknowledgment of payment. The MPS 120 sends acknowledgment of payment to the customer's mobile payment application 110.

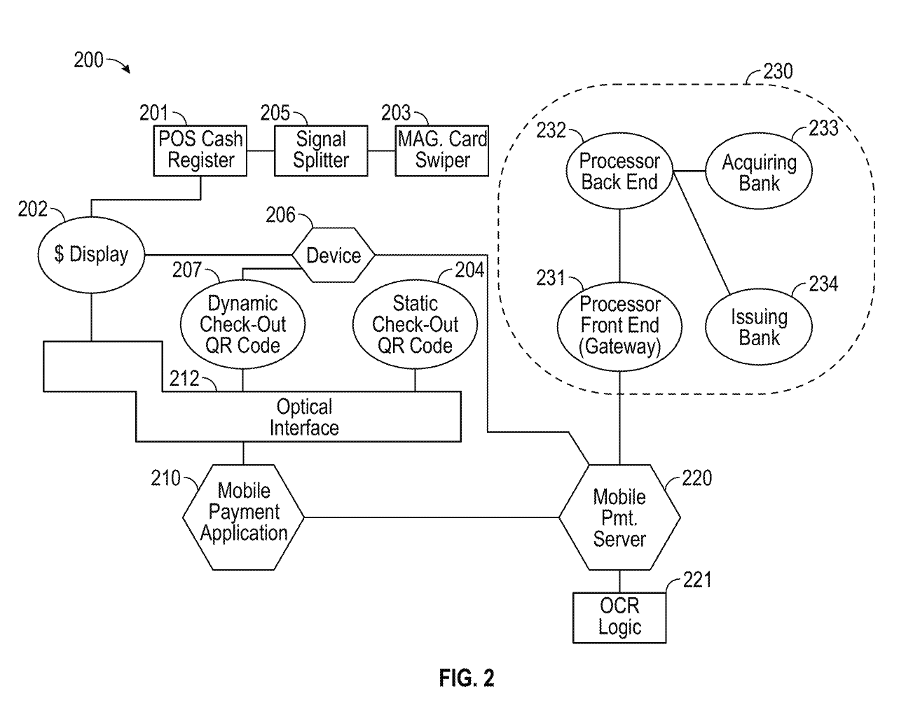

A process 200 and architecture for a second preferred embodiment of the present invention is also shown in FIG. 2 whereby the customer in addition to scanning a matrix/QR code 204, uses the camera 212 feature of the customer's mobile device to take a picture of the total due from a display monitor 202 (dot matrix, LCD, LED, or similar display monitor) connected to the merchant's POS Terminal 201. The mobile payment application 200 sends the picture to the MPS 220. The MPS 220 server uses OCR software 221 to decode the total amount due from the customer's picture. The MPS 220 also matches the merchant ID, POS Terminal ID obtained from the scanned QR code, and transmits all of this data to the processor to settle the transaction. The remaining steps of the transaction are completed in the same manner as the first preferred embodiment.

A third embodiment of the invention exists as shown in FIG. 2. by which a device 206 is connected between the POS 201 and the card swiper 203 either by implementing a software solution in the POS Terminal 201 or via an additional piece of hardware 206 connected via a RS-232 signal splitter 205 or similar connection means known in the art. The device 206 has a display monitor 202 (shown collectively with the display monitor 202 of the POS Terminal 201, but it is contemplated and included within the scope of the invention that the POS Terminal 201 and the device 206 could each comprise discrete display monitors) and basic computer functionality, internet connectivity and basic browser function. When the total amount due is generated by the POS terminal 201, that information is transmitted to the card swiper 203 and to the device 206. The device 206 has software which is activated upon receiving the total amount due from the POS Terminal 201 and also contains the Merchant ID and Terminal ID data relative to its location. The device 206 transmits the total amount owed, plus merchant ID and POS ID to the MPS 220 (first data set). The MPS 220 enters a receiving mode and is ready to receive further data. The customer scans a static matrix/QR code 207 with a mobile payment application 210 resident on the customer's mobile device, and is taken to the MPS 220. The matrix/QR code 204 contains data including merchant ID, POS ID, processor information (second data set). Upon being scanned, this data is transmitted to the MPS 220. As in the first preferred embodiment disclosed above, multiple matrix/QR codes 204 may be implemented allowing for connectivity to multiple variant payment platforms. The MPS 220 compares the two data sets, verifying that the IDs are the same, recombining the data, retrieves the customer's financial instrument/credit card information from a PCI compliant environment, and sends a request to the processor 230 for settlement of the transaction with this recombined data and payment information. The processor 230 completes the transaction and sends notification to the POS terminal 201 and/or card swiper 203 of the transaction results. The MPS 220 sends back transaction results to the customer's mobile payment application 210 which is viewable by the customer.

A fourth embodiment is similar to the third embodiment disclosed above with the addition of the device 206 being connected to a display 202 which can generate a dynamic QR code 207. The device 206 may also have one or more programmable hotkeys that each communicate with different MPS 220 allowing the device 206 to display dynamic matrix/OR codes 207 compatible with variant mobile payment application/MPS combinations.

That which is claimed is:

1. A computer-implemented method, executed by a payment processing system for processing payments, comprising:
receiving, through a payment application running on a mobile device of a customer, QR code data from an optical scanning device of the mobile device, the QR code data comprising a Merchant identification (ID), a point-of-sale (POS) Terminal ID, and merchant processor information;
receiving, through the payment application, a client transaction settlement request comprising the QR code data and a customer ID;
receiving, through the payment processing system, a processor transaction settlement request comprising the Merchant ID, the POS Terminal ID, and a transaction amount;
upon receiving both the client transaction settlement request and the processor transaction settlement request,
verifying, by the payment processing system, each of the Merchant ID and POS Terminal ID are identical between the client transaction settlement request and processor transaction settlement request;
combining, by the payment processing system, the client transaction settlement request and processor transaction settlement request into a combined transaction settlement request comprising the Merchant ID, the transaction amount, and customer financial instrument information; and
transmitting, by the payment processing system, the combined transaction settlement request to a processor payment gateway;
receiving, by the payment processing system, a transaction result; and
transmitting, by the payment processing system to the payment application, the transaction result.

2. The method of claim 1 further comprising:
receiving, through the payment application, an image of the transaction amount from the optical scanning device;
receiving, through the payment processing system, the picture of the transaction amount; and
determining, by the payment processing system, the picture of the transaction amount to determine a transaction amount.

3. The method of claim 2 further comprising verifying, by the payment processing system, that the transaction amount determined from the image of the transaction amount is identical to the transaction amount received from the processor payment gateway.

4. The method of claim 1 further comprising:
receiving, through the payment application, customer financial instrument information; and
receiving, through the payment processing system from the payment application, the customer financial instrument information.

5. The method of claim 1 further comprising retrieving, by the payment processing system, customer financial instrument information from a PCI-compliant environment.

6. The method of claim 1 wherein the QR code data is comprised by a dynamic QR code.

7. The method of claim 1 wherein the processor transaction settlement request is received from a processor payment gateway.

8. The method of claim 1 further comprising:
receiving, through a merchant information receiving system, a transaction amount; and
receiving, by the payment processing system from the merchant information receiving system, the processor transaction settlement request.

9. The method of claim 8 wherein the merchant information receiving system is software resident on a merchant POS terminal.

10. The method of claim 8 wherein the merchant information receiving system is a device positioned in communication with a merchant POS terminal and a card-reading device.

11. The method of claim 10 wherein the merchant information receiving system comprises a display operable to display a QR code comprising the OR code data.

12. The method of claim 11 wherein the QR code is a dynamic QR code.
